(19) United States
(12) Patent Application Publication
(10) Pub. No.: US 2015/0132425 A1
(43) Pub. Date: May 14, 2015

(54) 3D Printer Station

(71) Applicants: Alberto Daniel Lacaze, Potomac, MD (US); Karl Nicholas Murphy, Rockville, MD (US)

(72) Inventors: Alberto Daniel Lacaze, Potomac, MD (US); Karl Nicholas Murphy, Rockville, MD (US)

(21) Appl. No.: 14/538,936

(22) Filed: Nov. 12, 2014

Related U.S. Application Data
(60) Provisional application No. 61/903,370, filed on Nov. 12, 2013.

(51) Int. Cl. B29C 67/00

(52) U.S. Cl. CPC B29C 67/0088; B29C 67/0055; B33Y 30/00; B33Y 50/02; B29L 2031/777
USPC 425/144; 425/375; 425/145; 425/150

(57) ABSTRACT

A printing station teaching a control chamber for printing that is either part of the 3D printer or in which the 3D printer is enclosed. Additionally, the printing station must be equipped with assembly directions for building various devices from two or more printed component parts, an inventory of non-printable parts, a robot or other automated means for selecting and combining component parts into devices, as well as downloadable software and encryption for securing the devices and limiting their applications. Additionally, the printing station teaches a chamber either integrated with or enclosing the 3D printer to provide temperature, pressure, and humidity control during the printing process.

### CROSS REFERENCE TO RELATED APPLICATIONS

This application claims priority from U.S. Provisional Patent Application Ser. No. 61/903,370, entitled “3D Printer Station”, filed on 12 Nov. 2013. The benefit under 35 USC §119e of the United States provisional application is hereby claimed, and the aforementioned application is hereby incorporated herein by reference.

### FEDERALLY SPONSORED RESEARCH

Not Applicable

### SEQUENCE LISTING OR PROGRAM

Not Applicable

### TECHNICAL FIELD OF THE INVENTION

The present invention relates generally to rapid prototyping using 3D printers. More specifically, the present invention relates to rapid prototyping using 3D printers in the battlefield, or other locations, whereby operators can build, repair, or update deployed equipment by accessing a database of components providing detailed information for selection and printing on a 3D printer.

### BACKGROUND OF THE INVENTION

Recent conflicts have illustrated the dynamic nature of modern conflicts. In a dynamic battlefield, providing the right tools to the warfighter is a difficult challenge given current procurements and deployment strategies. Fighting nontraditional armies necessitates quick and reasonable responses to non-traditional weapons and dangers. Compare this philosophy with past conflicts where US Forces and allies could rely on research and development cycles develop weapons and counter-weapons of opposing armies. While non-traditional weapons have many detriments, their strength lies in the speed with which new weapons can be created. To properly respond to new threats these weapons create, rapid countermeasure development and deployment is of paramount importance.

The DoD is attempting to address this problem by rapidly developing requirements, developing solutions, and streamlining the procurement process. This strategy has had some success; however, it is very common for a newly-deployed system from this methodology addressing a now obsolete problem. In other words, the new enemy tactic could not be continued long term or warfighters adapted using suboptimal methods and made this new tactic not worth continuing. Thus, the problem simply “went away.” Clearly, this case leads to a large amount of development and procurement waste.

The present invention teaches a system, method, and devices that are capable of revolutionizing the ability to adapt the tools to the warfighter at rates that are not currently achievable by status quo procurement and deployment processes. In order to manufacture such devices, printing must be completed in a controlled setting. The setting must be controlled in two main areas. The first control is the physical printing area. The physical printing area must be adapted to the surrounding environmental conditions for optimum printing. Additionally, to properly execute remote printing a facility with supplies, raw materials, and the proper computer resources must be provided and function in a lock step manner.

### SUMMARY OF THE INVENTION

The system and method of deployable on-site manufacturing using 3D printing taught by the present invention is a low cost approach to manufacturing any of thousands of designs at any location. Crowd-sourcing populates a large library of models that can be produced using a small set of standard parts and 3D printed components, as well as highly specialized products. In one embodiment, a vacuum metallization process is used in combination with the 3D printer allows printing of antennas designed for a particular frequency, beam form, amplification, size, and weight. These highly specialize products are printed and assembled on-site, as needed. Uses include disaster sites, emergency situations, remote operations, military operations, and homeland security.

The proposed apparatus and method for a printing station teaches a control chamber for printing that is either part of the 3D printer or in which the 3D printer is enclosed. Additionally, the printing station must be equipped with assembly directions for building various devices from two or more printed component parts, an inventory of non-printable parts, a robot or other automated means for selecting and combining component parts into devices, as well as downloadable software and encryption for securing the devices and limiting their applications.

### DEFINITIONS

“3D printing material” is any material selected and used in a 3D printer. Material selection is based on a few important factors, like type, minimum thickness, texture and cost. Materials can include NYLON: (Polyamide and other Polymers), ABS: (Home printers), RESIN: (Multiple options), STAINLESS STEEL, GOLD & SILVER, TITANIUM, CERAMIC, GYPSUM, CLAY, and even food items such as dough and chocolate.

### BRIEF DESCRIPTION OF THE DRAWINGS

The accompanying drawings, which are incorporated herein an form a part of the specification, illustrate the present invention and, together with the description, further serve to explain the principles of the invention and to enable a person skilled in the pertinent art to make and use the invention.

FIG. 1 is a flow chart illustrating the method of the present invention;

FIG. 2 is a flow chart illustrating the method of the present invention;

FIG. 3 is a flow chart illustrating the method applied in the field in one exemplary device that may be comprised of a plurality of interchangeable parts that can be chose from the library, printed by a 3D printer, and assembled in the field based on select criteria; and

FIGS. 4-5 are flow charts illustrating how crowd-sourcing for the library of models and software is implemented.

### DETAILED DESCRIPTION OF THE INVENTION

In the following detailed description of the invention of exemplary embodiments of the invention, reference is made to the accompanying drawings (where like numbers represent like elements), which form a part hereof, and in which is shown by way of illustration specific exemplary embodiments in which the invention may be practiced. These embodiments are described in sufficient detail to enable those skilled in the art to practice the invention, but other embodiments may be utilized and logical, mechanical, electrical, and other changes may be made without departing from the scope of the present invention. The following detailed description is, therefore, not to be taken in a limiting sense, and the scope of the present invention is defined only by the appended claims.

In the following description, numerous specific details are set forth to provide a thorough understanding of the invention. However, it is understood that the invention may be practiced without these specific details. In other instances, well-known structures and techniques known to one of ordinary skill in the art have not been shown in detail in order not to obscure the invention. Referring to the figures, it is possible to see the various major elements constituting the apparatus of the present invention.

Rapid prototyping or 3D printing has been a dream of engineers and architectures for centuries. In the past decade, rapid prototyping machines have evolved some significant characteristics that can make them useful for this problem.

The materials utilized by rapid prototyping machines in the 1990's and early 2000's used to be clay composites that were mainly designed to provide aesthetical confirmation of the design but were not designed to be functional prototypes. This has changed in the late 2000's. ABS and ABS-Plus material can now be used by a large number of 3D printers. The models built with these printers are not only working prototypes, they can be actual parts that provide very similar mechanical characteristics to their injection molded counterparts.

The cost of the machines has changed from $100K in the 1990s to $2-20k at the present time with some of the smallest machines in the $1K range. The polymer or ceramic that these machines utilize costs about $4 per cubic inch. The machine size has decreased with time. What was once the size of a car has been transformed into a machine possibly as small as a small, carry-on piece of luggage.

Titanium based 3D printers are being developed; although not ready for daily use, these printers will provide new materials to further increase the repertoire of possible devices in the near future. The process will be able to generate mechanical designs that would be impossible to machine using conventional means.

As expected, field repair of these systems will become trivial by reprinting parts that have been broken, lost, or worn out. Standard parts like motors can be reused, and polymer or ceramic can be recycled, further minimizing the operational footprint. These parts can be printed by untrained personal. Parts that would be hard or impossible to machine can easily be generated in minutes.

All deployed systems are a compromise between the needs of the operator, the cost of the system, and the logistic trail that they generate. The complicated balance between these usually opposing goals generates compromises that reduce the capabilities and frustrates operators.

Deployable On-Site Manufacturing Using 3D Printing is a low cost approach to manufacturing any of thousands of designs at any location. This approach uses crowd-sourcing to populate a large library of models that can be produced using a small set of standard parts (e.g. motors, controller, or cameras), and 3D printed components. The highly specialize products are printed and assembled on-site, as needed. Uses include disaster sites, emergency situations, remote operations, military operations, and homeland security. A deployable on-site manufacturing using 3D printing process results in lower costs as a few standard non-printed parts are cheaper to buy and require less logistical tail. The deployable on-site manufacturing using 3D printing process chooses from thousands of specialized designs, then print and assemble on site. Crowd-sourcing allows fast design creation and revision without the logistic tail with provides more flexibility in comparison to other manufacturing processes.

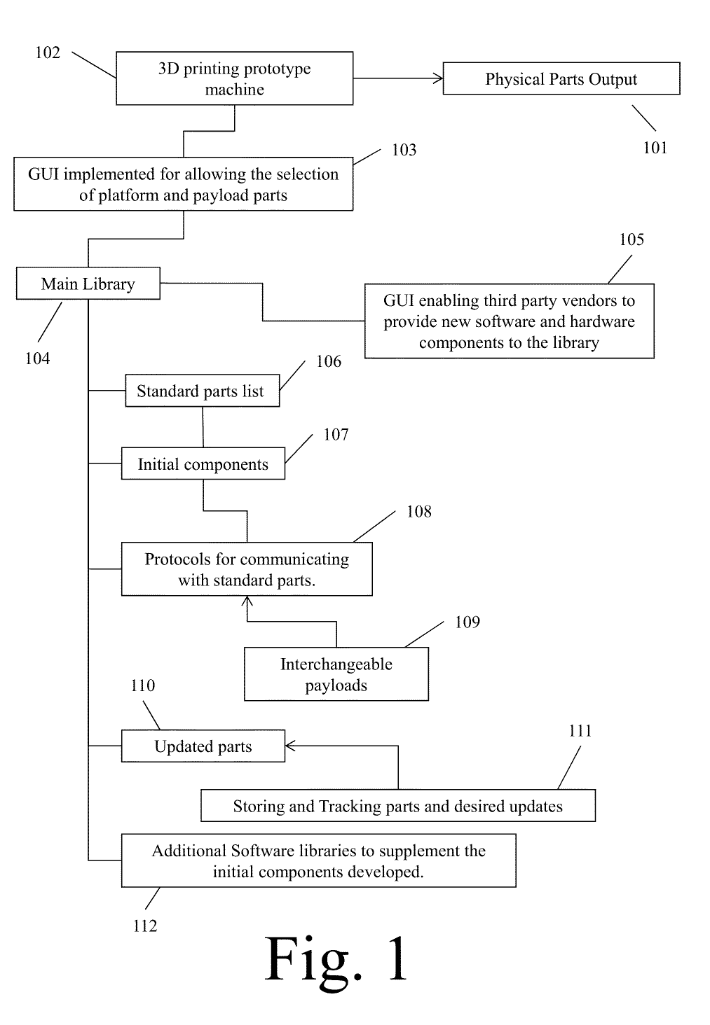

As shown in FIG. 1, the present invention will be comprised of developing an improved 3D printing prototype machine or using a 3D printing prototype machine 102 already known in the art for the creating and output of physical parts 101. The present invention will define a standard parts list 106 and develop a methodology for creating a library 104 with interchangeable payloads 109. Protocols 108 will be created for communicating with standard parts 106, update parts 110, and initial components 107. A simple interface 103 will be implemented for allowing the selection of platform and payload parts 106. A library 104 will be maintained that stores and tracks parts and desired updates 111. Additional software libraries and a store 112 will allow third party vendors to provide new software and hardware components to the main library 104 to supplement the initial components 107 developed.

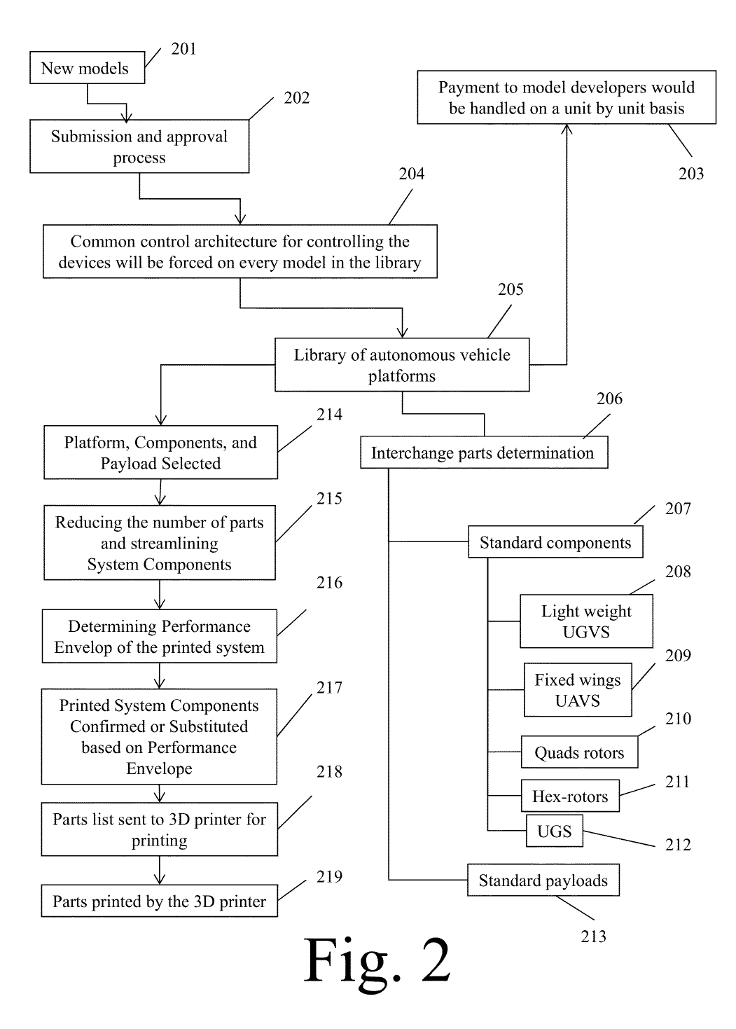

As shown in FIG. 2, a library of autonomous vehicles platforms 205 will be created utilizing the standard components 207 and the 3D printer 102. These libraries 205 will include a variety of light weight UGVS (unmanned aerial vehicle systems) 208, fixed wings UAVS 209, quads rotors 210, hex-rotors 211, UGS (unmanned ground systems) 212, etc. The library 205 will also include a variety of standard payloads 213 (for radios, explosives, etc) that would be interchangeable from platform to platform and a module for interchange parts determination 206. Each model in the library 205 will provide the operator with a performance envelop of the printed system. For example, a quad-rotor will have the expected flight time, and max payload, speed, etc.

In use, one or more components, and one or more payloads will be selected 214 from the library 205. The number of parts will be reduced and streamlined as determined by the system components 215. The performance envelope of the printed system will be determined 216 and the operator can then review the performance envelop information and either confirm or substitute printed system components based on the performance envelope and desired changes 217. Upon confirmation of the printed system components, the parts list is sent 218 to the 3D printer 102 and the parts are printed 219 by the 3D printer 102.

In order for developers to create new models 201 for these libraries, a submission and approval process 202 will be created. These new model devices 201 will be added to the printer's repertoire and library 205, allowing a warfighter to print the new models 201 as needed. A common control architecture 204 for controlling the devices will be forced on every model in the library.

Payment to model developers 203 would be handled on a unit by unit basis. The mechanical structure of the system will be virtually free making the systems low cost and virtually disposable.

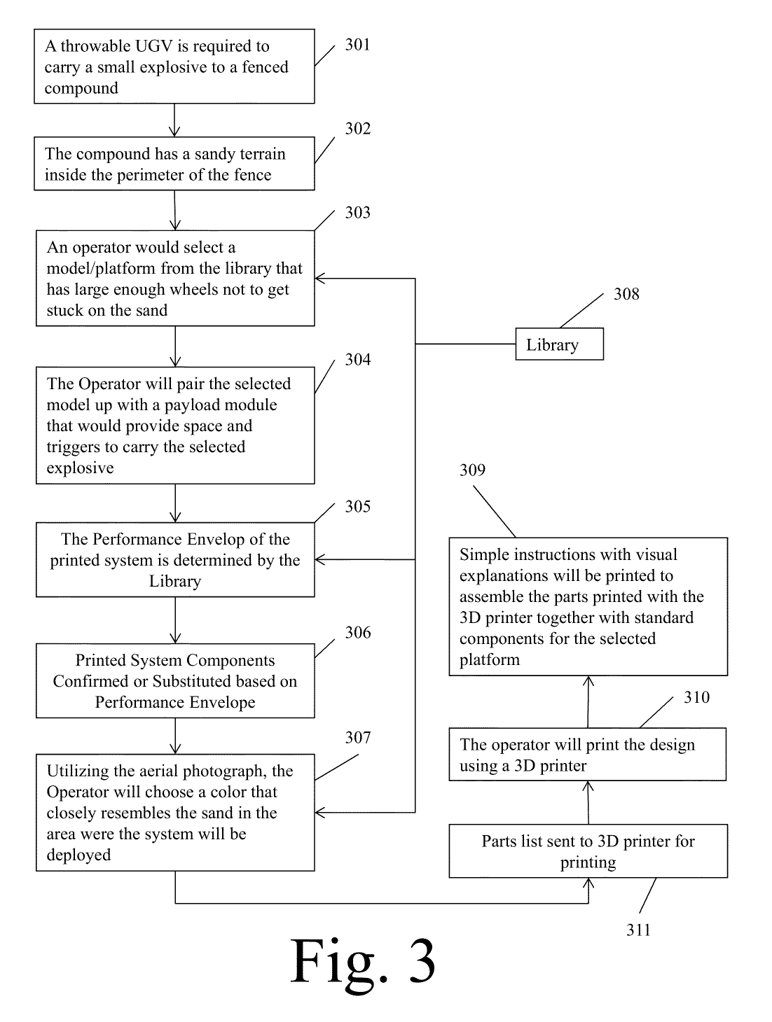

In one example shown in FIG. 3, a throwable UGV (unmanned ground vehicle) is required to carry a small explosive to a fenced compound 301. The compound has a sandy terrain inside the perimeter of the fence 302. An operator would select a model from the library 308 that has large enough wheels not to get stuck on the sand 303. He will pair it up with a payload module that would provide space and triggers to carry the selected explosive 304. The performance envelope of the printed system is determined 305 by the library 308. The operator can then confirm or substitute the system components 306 based on the determined performance envelope of step 305. By utilizing an aerial photograph, he will choose a color that closely resembles the sand in the area were the system will be deployed 307. The operator will print the design 310 using a 3D printer 102 by sending the parts list 311 to the 3D printer 102. Simple instructions 309 with visual explanations will be printed to assemble the parts printed with the 3D printer together with standard components from the kit (motors, radios, etc). The system should be ready to use within a few hours. If these systems are successful, a simple pick and place arm could be added to the 3D printer to automatically finalize the assembly of the system.

Although, the system in the above example could have been created and manufactured in the US. It would not be possible to have such a wide variety of systems deployed. Consider the aforementioned scenario, where a throwable UGV (unmanned ground vehicles) capable of traversing sand, carrying an explosive, and having a sand yellow color. Although feasible to construct, such an UGV would not be a good candidate for deployment because it is too specialized for the particular mission. This and other highly specialized models can be available in the libraries available to the warfighter without generating an extra logistic trail for systems, parts, or controllers.

The advantages of having the right tool for the right job are self-evident and could provide a new level of adaptability to warfighers. Very often, we hear from warfighters returning home: “if I could only have had so and so functionality in the field.” It is our experience that special operators are trained to be highly innovative and adaptable to the environment customizing COTS devices to produce and utilize tactically functional systems. We have seen operators transform house heaters into microphones and cell phones into tracking devices. Obviously, the proposed system cannot be used to build a flail or bullet proof armor, but we believe that in the hands of inventive operators, the system will quickly become invaluable.

UGVs (unmanned ground vehicles) and UAVs (unmanned aerial vehicles) are a perfect candidate for this manufacturing process. In general, these devices need to be highly specialized for the operation, are expensive, and are being produced in an astonishing variety of capability classes creating a logistics and training nightmare. In theater, they are usually treated almost as consumables tend to have relatively short lifetimes (sometimes measured in hours). Attempts by the government to own the design of these systems are likely to fail because by the time the government builds a system that works, it is likely to be obsolete.

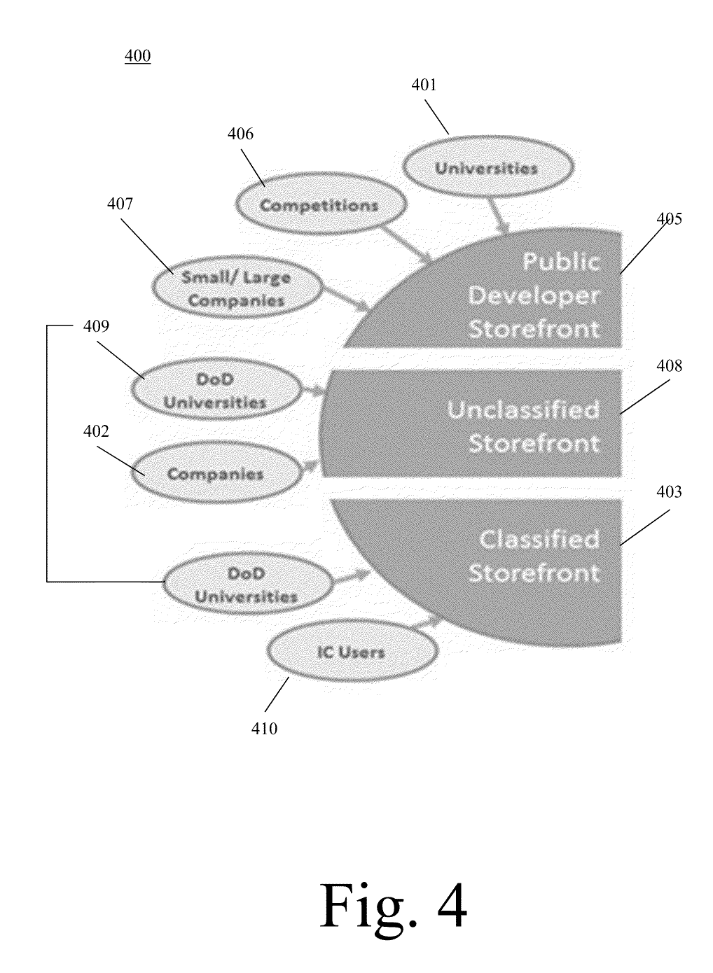

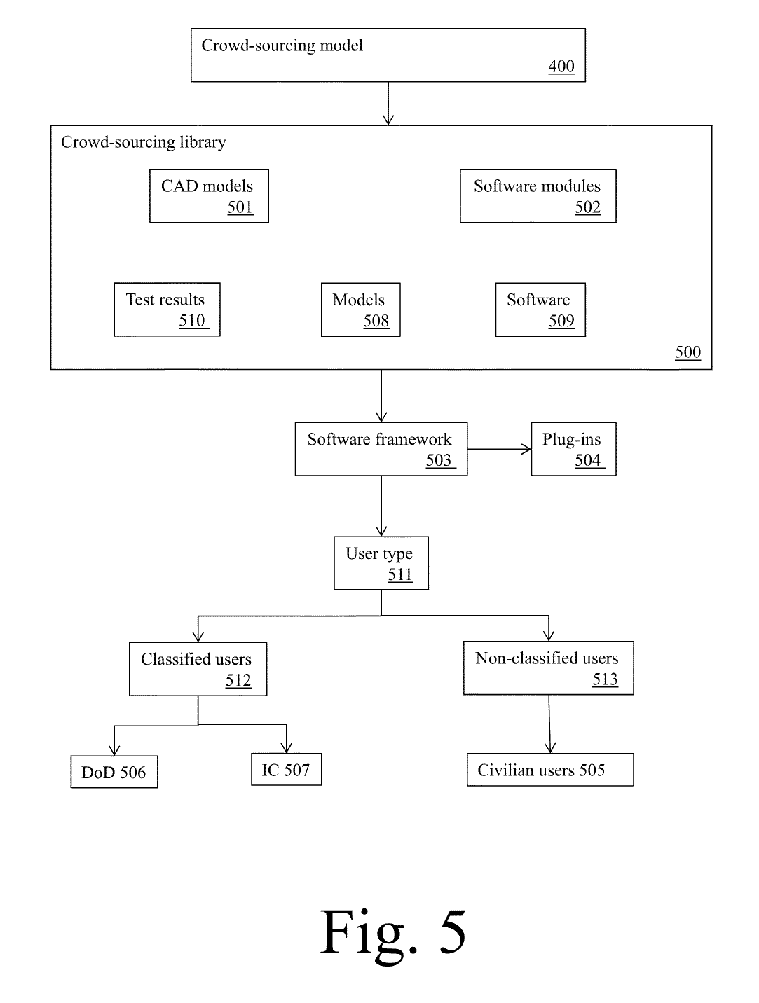

In another embodiment, crowd-sourcing 400 for the library of models and software is implemented as show in FIG. 4. Universities 401, companies 402, individuals, and government agencies develop the models and accompanying software to populate the library. Intellectual property of the designers is protected by the library (from source to printer), and the system compensates developers based on the number of models instantiated by the users. A public developer storefront 405 is developed and populated by universities 401, competitions 406 and small or large companies 407. An unclassified storefront 408 is populated by DoD Universities 409 and companies 402. A classified storefront 403 is populated by DoD universities 409 and IC users 410 so that parts are protected and can not be copied by unclassified parties.

Crowd-souring provides a compensation mechanism for STEM initiatives and maintains the IP of the developer. Crowd souring provides a simple proven and understood business model (e.g. Android/Applestore) as the contracting mechanism and allows a non-traditional contractor such as a highly intelligent kid or young adult or a Wounded Warrior a direct pathway to deployment. The DoD/Government benefits from the crowd-sourcing model which allows the intelligence community to develop derivative models from nontraditional sources.

In the crowd-sourcing embodiment, a crowd-sourcing library 500 is a repository of CAD models 501 and software modules 502 obtained using the crowd-sourcing model 400. A software framework 503 is supplied that provides plug-ins 504 for the standard parts and can be enhanced by developers to add functionality to the models in the library. The software infrastructure 503 is sufficiently simple to provide a low barrier of entry to emphasize the STEM/higher education benefits. The crowd-sourcing library 500 maintains performance test results 510 provided from a variety of sources: civilian users 505, DoD 506, DHS 506, IC 507, etc. Models 508, software 509, and test results 510 are segregated by the user type 511—the classified users 512 see the complete library, while non-classified users 513 see only models 508 of their user type 511.

The crowd-sourcing library 500 results in performance that can be achieved by specialization of design (i.e. a robot with wheels that works well on carpet). Current robotic systems are a compromise between a large number of missions and users while the system and method of the present invention provides the right equipment for the mission. The crowd-sourcing library enables classified users to benefit from models and software provided in a crowd-sourcing framework. Specialized libraries can go beyond robotics to become a standard mechanism for delivering parts on an as-needed basis. The crowd-sourcing library will include specialization for devices to carry customized loads, brackets, power, and communication devices to match ever-changing payloads, adding flexibility for mission needs.

Each government agency will decide what should be part of their standard parts supply kit, and add or remove parts as needed. Initially the parts kit will be composed of essential expected standard items: motors, motor controllers, batteries, small computer, and cameras. The kits will be composed of commodity components or government owned designs. As a result of the system and method of the present invention, a reduced logistical tail compared with the current state of robotics where a large variety of proprietary parts with similar or identical functionality need to be stocked warehoused and deployed occurs. The Government owns the parts list and “custom” proprietary parts are vetted/approved and only used as a last resort, thus reducing government costs.

The system and method of the present invention provides an inherently safe mechanism of building devices in situ for the intelligence community since, even if parts are found, the motive and end product will be concealed. Commodity parts will be simpler to replace and the government will achieve greater quantity savings as multiple contractors bid prices down. The system and method of the present invention not only has the potential of speeding up the deployment, but it also has the potential of making the systems significantly cheaper.

The system of the present invention requires that a 3D printer be either deployed or pre-positioned close to the operational/mission/disaster site. The preferred mechanism for most agencies will be to have a portable laboratory that provides the facilities for storing the parts kit, polymers, 3D printer, power, and communications. Design cycles can be performed at the mission/disaster site. Users only print what they need and reuse parts if mistakes are made or a device is no longer needed (i.e. a motor comes out of robot and into a pump). Rapid modifications of the design can be done onsite and offsite using a common framework rather than with “duct tape”.

With respect to Model Testing, approved US-based labs will be used to test and categorize performance characteristics of models and parts in the library. These labs will provide cross agency performance measures and maintain US technology superiority. A common test methodology across agencies will reduce testing costs. Clear test parameters and results repository will be used with a bridge to conventional manufacturing performance evaluations. STEM-based competitions will test and select winning designs

3D printers are now being used by the military and other organizations to bring manufacturing facilities to various locations around the globe which may or may not be hospital to manufacturing and the printing process.

In military applications, the location, terrain, and transportation requirements dictate that the device and its supporting components be very rugged and be able to perform under a wide variety of locations, conditions, and environmental factors.

To overcome these challenges, the present invention teaches a 3D printer integrated with or enclosed in a controlled chamber. This chamber could be integrated with an existing 3D printer to enclose the print area or it could be larger to enclose the entire printer or the entire mobile print station, which would readily be deployed inside a container, such as a shipping container.

The chamber controls and regulates temperature, humidity, and Barometric pressure to ensure that printing is done in a controlled atmosphere. The 3D printing process is very sensitive to temperature, humidity, and Barometric pressure as the ink must be highly controlled to a specific melting point for proper printing and adhesion between layers.

In another embodiment of the present invention, when a controlled container or chamber is unworkable or not-feasible for deployment, control of the nozzle heating and flow/feed rate is taught where the temperature of the polymer or ceramic and the flow/feed rate of the polymer or ceramic is adjusted based on the atmospheric conditions such as temperature, humidity, and Barometric Pressure.

In some applications, the 3D printer will be deployed at very high altitudes in aircraft or one land, with a resulting low Barometric pressure, or at depths below the ocean under in submarines with varying artificial pressures. In these conditions, print quality is greatly affected. Barometric pressure has been found to have the most effect on print quality. The station or equipment must manually or automatically be adjusted to the temperature, humidity, and especially the Barometric pressure when printing will occur. If adjustments are not performed manually, a reference table will be provided to the user as part of the printing station so that the polymer or ceramic temperature and flow/feed rate of the polymer or ceramic as it exits the nozzle can be accurately adjusted to the present conditions.

The reference table would be comprised of printing parameters for the filament temperature of the 3D printer head, the chamber temperature, the flow/feed rate, and the motion speed of the printing head versus various changes in temperature, Barometric pressure, and humidity. The optimal setting for each of the printing parameters, the filament temperature of the 3D printer head, the chamber temperature, the flow/feed rate, and the motion speed of the printing head for each combination of temperature, Barometric pressure, and humidity would be provided. Printing adjustments may be performed manually or automatically by the 3D printer based on manual user input or sensor input.

In another embodiment of the present invention, vibration is a concern during use and must be taken into consideration as a variable just as important as temperature, barometric pressure, and humidity. When a 3D printer is deployed in an airplane, submarine, or ship environmental conditions, that effect motion and vibration are disruptive to the printing process. Such motion or vibration during this type of deployment must be taken into consideration by the printer when creating a 3D part or the printer will misprint. Printing adjustments may be performed manually or automatically by the 3D printer based on manual user input or sensor input to compensate for vibration or motion in the printing environment.

A CAD file may also include information not just to make the desired part, but to set specifics with respect to or material selections from the file for the filament temperature of the 3D printer head, the chamber temperature, the flow/feed rate, and the motion speed of the printing head versus various changes in temperature, Barometric pressure, and humidity. The file may also contain printing information to control the motion speed of the printing head in certain directions based on the environmental conditions of temperature, Barometric pressure, and humidity as well as motion or vibration.

The printing station should, in a deployment embodiment must also be supplied with raw material for the printer and an inventory of non-printable parts and components that can be combined to make a plurality of devices. A computer and software is required to be provided as assembly instructions and to provide a reference for all possible devices that can be constructed using a combination of inventoried parts and potential printed components. This information, also known as provided by reference material, must also be encrypted or protected from potential capture by opposing forces.

In another embodiment of the present invention, the printing station can also be further comprised of a robot or other automated assembly means for automatically selecting inventory and printed parts and assembling desired devices from the selected component parts.

Thus, it is appreciated that the optimum dimensional relationships for the parts of the invention, to include variation in size, materials, shape, form, function, and manner of operation, assembly and use, are deemed readily apparent and obvious to one of ordinary skill in the art, and all equivalent relationships to those illustrated in the drawings and described in the above description are intended to be encompassed by the present invention.

Furthermore, other areas of art may benefit from this method and adjustments to the design are anticipated. Thus, the scope of the invention should be determined by the appended claims and their legal equivalents, rather than by the examples given.

The embodiments of the invention in which an exclusive property or privilege is claimed are defined as follows:

1. A printing station comprising:
a computer capable of storing and executing software and sending printing commands to a 3D printer in the field;
a 3D printer; and
providing a reference for adjusting the temperature and flow/feed rate of the heated 3D printing material exiting the printer head based on atmospheric conditions.

2. The printing station of claim 1, wherein the temperature of the heated 3D printing material exiting the printer head is adjusted based on temperature, humidity, barometric pressure or vibration.

3. The printing station of claim 1, wherein the flow/feed rate of the heated 3D printing material exiting the printer head is adjusted based on temperature, humidity, barometric pressure or vibration.

4. The printing station of claim 1, wherein the speed of motion of the head the printer head is adjusted based on temperature, humidity, barometric pressure or vibration.

5. The printing station of claim 1, wherein the temperature and flow/feed rate of the heated 3D printing material exiting the printer head is adjusted based on barometric pressure, humidity, barometric pressure, or vibration.

6. The printing station of claim 1, wherein the reference table is comprised of printing parameters for the filament temperature of the 3D printer head, the chamber temperature, the flow/feed rate and the motion speed of the printing head versus various changes in temperature, Barometric pressure, humidity or vibration.

7. The printing station of claim 4, wherein the optimal setting for each of the printing parameters, the filament temperature of the 3D printer head, the chamber temperature, the flow/feed rate and the motion speed of the printing head for each combination of temperature, Barometric pressure, and humidity are provided by reference material.

8. The printing station of claim 1, wherein printing adjustments may be performed manually or automatically by the 3D printer based on manual user input or sensor input.

9. The printing station of claim 1, wherein the building characteristics are encoded as part of the part model and can be interpreted by the printing station given the current conditions.

10. The printing station of claim 9, wherein the building characteristics are one or more from the group of temperature, barometric pressure, humidity, or vibration.

11. A printing station comprising:
a climate controlled container controlling and regulating temperature, humidity, and Barometric pressure for housing:
a computer capable of storing and executing software and sending printing commands to a 3D printer in the field;
a 3D printer in the field;
deploying a small number of standard components and platforms in the field with the computer and 3D printer;
providing a library of parts or devices for manufacturing by the 3D printer;
selecting printed parts for use in creating components to be used alone or in combination with the standard components; and
creating the selected parts by sending the printing information from the computer to the 3D printer for printing.

12. The apparatus of claim 11, wherein the climate control chamber is integrated with the 3D printer

13. The apparatus of claim 11, wherein the container is a shipping container.

14. The apparatus of claim 11, further comprising a robot or other automated assembly means for automatically selecting inventory and printed parts and assembling desired devices from the selected component parts.

15. The apparatus of claim 11, further comprising
an inventory of non-printable parts and components that can be combined to make a plurality of devices;
a computer and software providing assembly instructions and a reference for all possible devices that can be constructed using a combination of inventoried parts and potential printed components.

16. The apparatus of claim 15, wherein the information stored on the computer is encrypted or uniquely keyed to the printer so that the printer will only print a single part.

17. A printing station comprising:
a computer capable of storing and executing software and sending printing commands to a 3D printer in the field;
a 3D printer;
providing a reference for adjusting the temperature and flow/feed rate of the heated plastic exiting the printer head based on atmospheric conditions;
an inventory of non-printable parts and components that can be combined to make a plurality of devices;
a computer and software providing assembly instructions and a reference for all possible devices that can be constructed using a combination of inventoried parts and potential printed components; and
wherein the information stored on the computer is encrypted or uniquely keyed to the printer so that the printer will only print a single part.
